(19) United States
(12) Patent Application Publication
(10) Pub. No.: US 2004/0154642 A1
(43) Pub. Date: Aug. 12, 2004

(54) Method of controlling drum-type washing machine

(75) Inventors: Kwang Soo Kim, Changwon-si (KR); Jae Mun Kim, Jinhae-si (KR); Sam Je Park, Gimhae-si (KR); Hyun Jae Lee, Jinju-si (KR)

Correspondence Address: MCKENNA LONG & ALDRIDGE LLP, 1900 K STREET, NW, WASHINGTON, DC, 20006, US

(73) Assignee: LG ELECTRONICS, INC.

(21) Appl. No.: 10/720,682

(22) Filed: Nov. 25, 2003

(30) Foreign Application Priority Data
Nov. 26, 2002 (KR) P2002-0073850

(51) Int. Cl. B08B 7/04

(52) U.S. Cl. 134/18; 8/158; 8/159

(57) ABSTRACT

A method of controlling a drum-type washing machine facilitates the removal of laundry from the drum after the completion of a wash cycle, by controlling the rotational speed/direction of a drum motor so that a force is applied to the drum, thereby separating the laundry from the inner surface of the drum, which becomes adhered thereto during a dewatering step. The method includes steps performing a wash cycle by respectively completing washing, rinsing, and dewatering steps according to a wash course; controlling the driving of the motor, after completion of the dewatering step, to apply a force to the drum; stopping the driving of the motor to allow the motor to freewheel and slow to a stop; and detecting a rotational speed of the motor as the motor freewheels. The force applied to the drum is an impacting force generated by temporarily braking the motor when the rotational speed of the motor reaches a predetermined rate or a shaking force generated by temporality driving the motor in one direction and then temporarily driving the motor in the opposite direction.

This application claims the benefit of Korean Application No. 10-2002-0073850 filed on Nov. 26, 2002, which is hereby incorporated by reference.

### BACKGROUND OF THE INVENTION

1. Field of the Invention

The present invention relates to a method of controlling a drum-type washing machine a drum-type washing machine, and more particularly, to a method of controlling the rotational speed/direction of a drum motor after the completion of a dewatering step, so that a force is applied to the drum sufficient to separate laundry from an inner surface of the drum, which becomes adhered thereto during the dewatering step.

2. Discussion of the Related Art

Generally speaking, a washing machine is an apparatus for washing laundry by performing washing, rinsing, and dewatering steps in accordance with a wash course as selected by a user Washing machines are typically categorized according to washing type and may include pulsator, agitator, and drum types.

A drum-type washing machine, as shown in FIG. 1, is comprised of a tub 2 for holding washing water and a drum 3 for holding laundry, rotatably installed in the tub and receiving a drive force of a motor 10 via a belt 11 to perform washing related steps. With laundry placed inside the drum 3, the tub 2 is filled with water to a predetermined level. Under such a load, the motor 10 is driven under the control of a microcomputer (not shown), to proceed the washing, rinsing, and dewatering steps in sequence, with the dewatering step requiring a high speed rotation of the motor.

Referring to FIG. 2, illustrating a drum-type washing machine control method according to a related art, washing (S1), rinsing (S2), and dewatering (S3) steps are performed according to a user-selected wash course. After completion of the dewatering step, the drive of the motor 10 is stopped (S4), so that the motor's rotation gradually comes to a stop (S5), under the control of the microcomputer. That is, the wash cycle terminates when the motor reaches a speed of zero revolutions per minute (rpm).

The high-speed rotation of the dewatering step creates a centrifugal force, pushing the laundry against the inner surface of the drum as the water is drawn away. This centrifugal force, taken in conjunction with the wetness of the rinsed laundry, causes the laundry to become collectively adhered to the drum's inner surface. Thus, removal of the laundry from the washing machine must be performed by a piece-by-piece separation of the laundry from the drum's inner surface, which is inconvenient.

### SUMMARY OF THE INVENTION

Accordingly, the present invention is directed to a method of controlling a drum-type washing machine that substantially obviates one or more of the problems due to limitations and disadvantages of the related art.

An object of the present invention, which has been devised to solve the foregoing problem, lies in providing a method of controlling a drum-type washing machine, which enables the convenient removal of laundry from the washing machine after a dewatering step, when the laundry collectively adheres to an inner surface of the drum, by controlling a motor rotating the drum at the termination of a wash cycle, such that an impacting or shaking force is applied to the laundry, to cause the laundry to fall away from the drum's inner surface.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a method of controlling a drum-type washing machine having a motor for driving a drum. The method comprises steps of performing a wash cycle by respectively completing washing, rinsing, and dewatering steps according to a wash course; and controlling the driving of the motor, after completion of the dewatering step, to apply a force to the drum. The method further comprises steps of stopping the driving of the motor to allow the motor to freewheel and slow to a stop; and detecting a rotational speed of the motor as the motor freewheels.

The force applied to the drum may be an impacting force generated by temporarily braking the motor when the rotational speed of the motor reaches a predetermined rate or may be a shaking force generated by temporality driving the motor in one direction and then temporarily driving the motor in a direction opposite to the one direction.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a general drum-type washing machine;

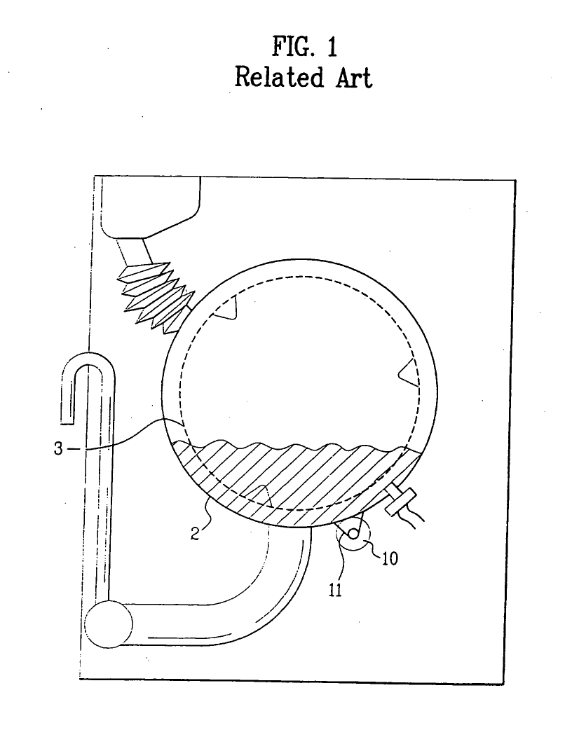

FIG. 2 is a flowchart of a drum-type washing machine control method according to a related art;

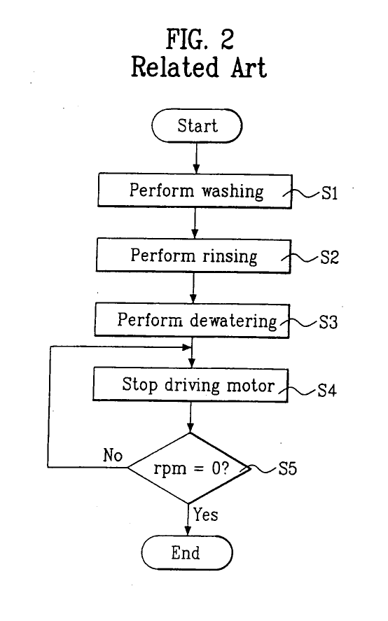

FIG. 3A is a flowchart of a drum-type washing machine control method according to one embodiment of the present invention;

FIG. 3B is a flowchart of a drum-type washing machine control method according to another embodiment of the present invention; and

FIGS. 4A and 4B are waveform diagrams of the drum motor operated according to the embodiments of FIGS. 3A and 3B, respectively.

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

The method of the present invention is directed towards a washing machine have a motor for driving a drum in which laundry is placed for a wash course including washing, rinsing, and dewatering steps.

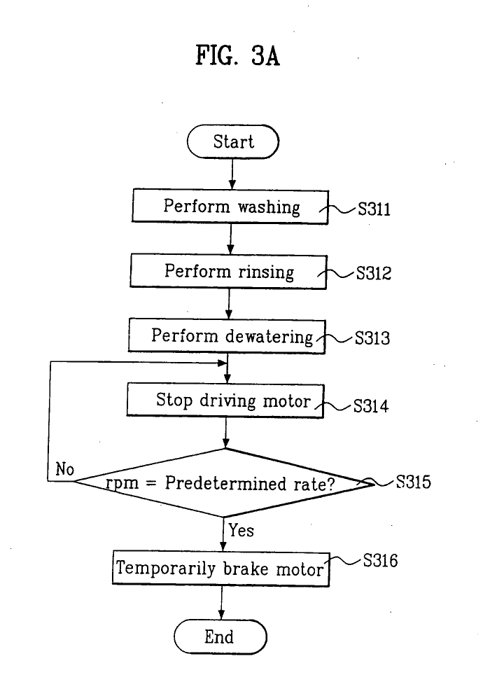

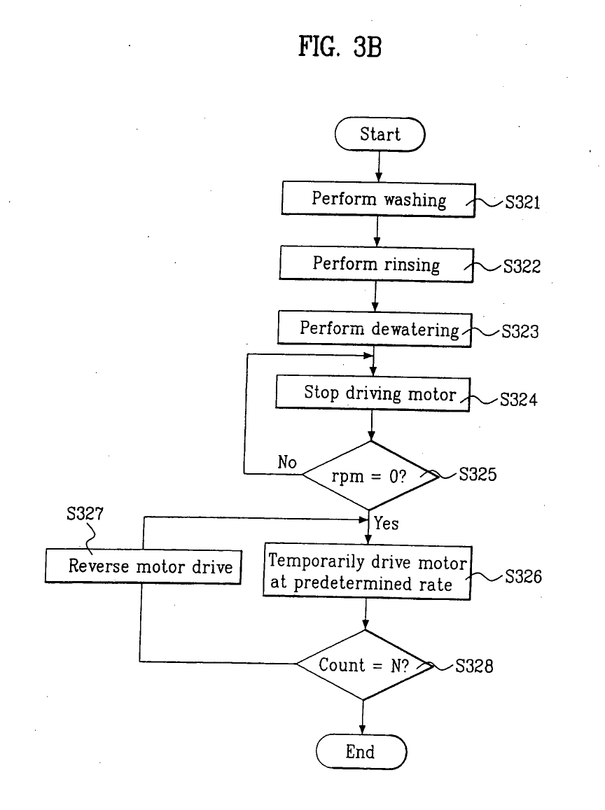

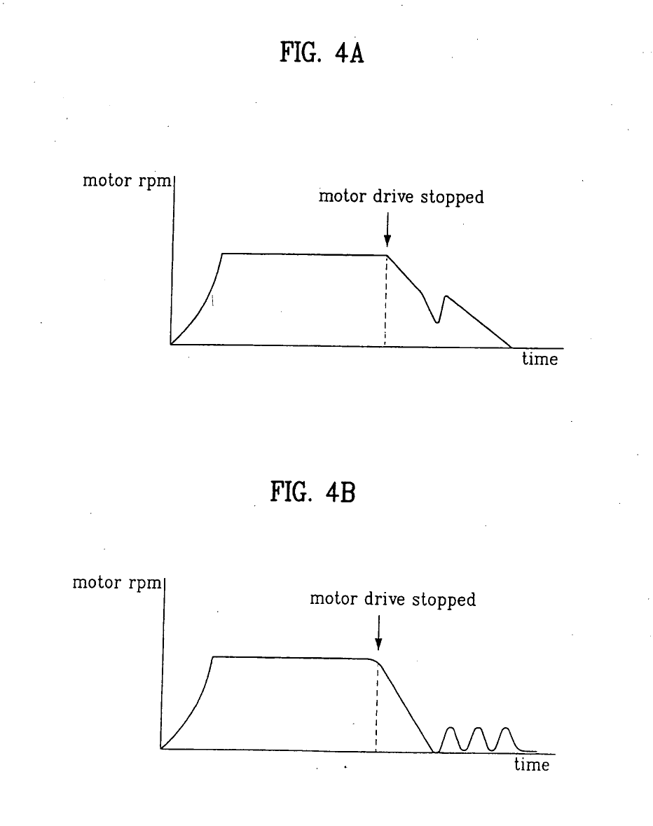

Referring to FIG. 3, illustrating a drum-type washing machine control method according to one embodiment of the present invention, washing (S311), rinsing (S312), and dewatering (S313) steps are performed according to a user-selected wash course. After completion of the dewatering step, the microcomputer stops driving the motor (S314). As the motor freewheels and slows to a stop, the motor's rpm is detected. When the motor's rotational speed reaches a predetermined rate (S315), the motor is temporally braked (S316) and then released, such that the motor speed is reduced sharply before reaching zero, as illustrated in FIG. 4A. As a result, an impacting force is applied to the drum so that the laundry, which is attached to the inner surface of the drum by a centrifugal force, becomes separated and falls to a lower area of the drum.

Referring to FIG. 3B, illustrating a drum-type washing machine control method according to another embodiment of the present invention, washing (S321), rinsing (S322), and dewatering (S323) steps are performed according to a user-selected wash course. After completion of the dewatering step, the microcomputer stops driving the motor (S324). As the motor freewheels and slows to a stop, the motor's rpm is detected. When the motor's rotational speed reaches zero rpm (S325), the motor is temporarily driven at a predetermined rate in one direction (S326) and is then immediately reversed (S327) to be driven temporarily driven at a predetermined rate in the opposite direction, such that the motor speed oscillates between zero and the predetermined rate, as illustrated in FIG. 4B. This rapid forwarding and reversing of the motor is repeated a predetermined number of times N (S328). As a result, a shaking force is applied to the drum so that the laundry, which is attached to the inner surface of the drum by a centrifugal force, becomes separated and falls to a lower area of the drum.

Accordingly, the present invention facilitates the removal of laundry from the drum of a drum-type washing machine after the completion of a wash cycle, by controlling the rotational speed/direction of a drum motor so that a shock or a shaking force is applied to the drum, thereby separating the laundry from the inner surface of the drum, which becomes adhered thereto during a dewatering step.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A method of controlling a drum-type washing machine having a motor for driving a drum, the method comprising steps of:
performing a wash cycle by respectively completing washing, rinsing, and dewatering steps according to a wash course; and
controlling the driving of the motor, after completion of the dewatering step, to apply a force to the drum.

2. The method as claimed in claim 1, wherein the force applied to the drum is sufficient to separate, from an inner surface of the drum, laundry adhered the inner surface of the drum during the dewatering step.

3. The method as claimed in claim 1, further comprising steps of:
stopping the driving of the motor to allow the motor to freewheel and slow to a stop; and
detecting a rotational speed of the motor as the motor freewheels,
wherein the force applied to the drum is an impacting force generated by temporarily braking the motor when the rotational speed of the motor reaches a predetermined rate.

4. The method as claimed in claim 1, further comprising steps of:
stopping the driving of the motor to allow the motor to freewheel and slow to a stop; and
detecting a rotational speed of the motor as the motor freewheels,
wherein the force applied to the drum is a shaking force generated by temporality driving the motor in one direction and then temporarily driving the motor in a direction opposite to the one direction.

5. The method as claimed in claim 4, wherein said controlling step is repeated for a predetermined count.
